(19) United States
(12) Patent Application Publication
(10) Pub. No.: US 2017/0185515 A1
(43) Pub. Date: Jun. 29, 2017

(54) Cpu remote snoop filtering mechanism for field programmable gate array

(71) Applicants: Bahaa Fahim, Santa Clara, CA (US); Samuel D. Strom, Folsom, CA (US); George H. Huang, Santa Clara, CA (US); Vedaraman Geetha, Fremont, CA (US); Yen-Cheng Liu, Portland, OR (US)

(72) Inventors: Bahaa Fahim, Santa Clara, CA (US); Samuel D. Strom, Folsom, CA (US); George H. Huang, Santa Clara, CA (US); Vedaraman Geetha, Fremont, CA (US); Yen-Cheng Liu, Portland, OR (US)

(21) Appl. No.: 14/998,298

(22) Filed: Dec. 26, 2015

(51) Int. Cl. G06F 12/08

(52) U.S. Cl. CPC G06F 12/0815; G06F 12/084; G06F 12/0891; G06F 2212/60; G06F 2212/621

(57) ABSTRACT

Apparatus and methods implementing a Remote Snoop Filter (“RSF”) for reducing unnecessary snoops to one or more Field Programmable Gate Arrays (“FPGAs”) in a hardware system by tracking the address and state of each cache line cached in the FPGA's cache. The apparatus include one or more processors, one or more FPGAs, and a system memory. Each processor further comprises a Caching and Home Agent (“CHA”), an L3 or Last Level Cache (“LLC”), and one or more cores wherein each core contains a core cache. The CHA implements and manages an RSF which tracks the address and state of each cache line stored in the one or more FPGAs. The hit/miss result from an RSF lookup is used by the CHA to determine whether or not to filter snoops to the FPGAs. A cache line miss in the RSF indicates that the requested cache line is not in any of the FPGAs and thus no snoop to the FPGA should be issued. This ensures that the FPGAs are generally not snooped unless necessary.

### BACKGROUND INFORMATION

A field-programmable gate array (“FPGA”) is an integrated circuit designed to be configurable by a user after manufacturing. Its ability to be reconfigured and customized to perform different functionalities, low non-recurring cost relative to ASIC (application-specific integrated circuit) designs, and capability to conduct parallel processing have made FPGA a popular choice for handling workload-specific tasks.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a schematic diagram illustrating a high-level view of an exemplary hardware system implementing a Remote Snoop Filter according to one embodiment.

FIG. 2 is a block diagram illustrating an uncore subsystem for a single socket CPU according to one embodiment.

FIG. 3 illustrates exemplary implementation of a Remote Snoop Filter according to one embodiment.

FIG. 4 is a block diagram illustrating a high-level view of a Cache and Home Agent according to one embodiment.

FIG. 5 is a flow chart illustrating operations and logic for implementing a Remote Snoop Filter for one or more Field Programmable Gate Arrays according to one embodiment.

FIG. 6A is a block diagram illustrating both an exemplary in-order pipeline and an exemplary register renaming, out-of-order issue/execution pipeline according to embodiments of the invention;

FIG. 6B is a block diagram illustrating both an exemplary embodiment of an in-order architecture core and an exemplary register renaming, out-of-order issue/execution architecture core to be included in a processor according to embodiments of the invention;

FIG. 7 is a block diagram of a single core processor and a multicore processor with integrated memory controller and graphics according to embodiments of the invention;

FIG. 8 illustrates a block diagram of a system in accordance with one embodiment of the present invention;

FIG. 9 illustrates a block diagram of a second system in accordance with an embodiment of the present invention;

FIG. 10 illustrates a block diagram of a third system in accordance with an embodiment of the present invention;

FIG. 11 illustrates a block diagram of a system on a chip (SoC) in accordance with an embodiment of the present invention;

FIG. 12 illustrates a block diagram contrasting the use of a software instruction converter to convert binary instructions in a source instruction set to binary instructions in a target instruction set according to embodiments of the invention.

### DETAILED DESCRIPTION

Embodiments of apparatus and methods implementing a remote snoop filter for reducing unnecessary remote snoop to one or more Field Programmable Gate Arrays (“FPGAs”) is described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not, shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. For clarity, individual components in the Figures herein may be referred to by their labels in the Figures, rather than by a particular reference number.

Integrating FPGAs and general-purpose processors (“CPU”) in the same system creates memory and cache access issues as the FPGA tend to on a slower cycle than the CPU and is generally unable to keep up with all the cache accesses and snoop requests issued by CPU. Thus, it would beneficial to restrict any necessary cache accesses and snoop requests to the FPGA to save bandwidth. However, CPUs such as server processors currently do not have the capability to filter snoops towards a specific socket (e.g., a CPU or FPGA). For local snoops, the server CPU includes a home agent implementation that uses memory directory states (if enabled) to filter snoops within the same socket. And while the memory directory includes various states, such as “A”/owned or “S”/shared, these states do not provide sufficient indication as to the specific socket that owns or shares the cache line due to insufficient per cache line storage in DRAM. Moreover, even though some home agent implementations may include improved cached directory schemes such as HitME and IODC that include a single CPU NodeID owner, these improved schemes are still limited in both capacity (i.e., tracking only few cache lines) and application (i.e., tracking only specific cache lines such as the heavily contested cache lines in HitME or the UC/WC stores in IODC) to be effective reduce unnecessary cache accesses and snoop requests towards a specific socket. As a result of the inability filter snoops towards a specific socket, the home agent has had to snoop all sockets whenever remote snooping is required.

For most server CPUs, filtering snoops to a particular socket has not been important as all remote sockets are either peer CPUs, which provide optimal snoop response latency, or external node controllers, which tend to have custom snoop filtering mechanism to save bandwidth. However, as part of the integration of FPGAs on a CPU package and allowing them to use a cache coherent interconnect as a mechanism to communicate to a CPU die, CPUs now need to provide the capability to both track and filter snoops to the FPGAs as the FPGAs are not able to keep up with cross-CPU snoop latencies. The inability to provide low snoop response latency significantly diminishes both memory bandwidth and overall performance.

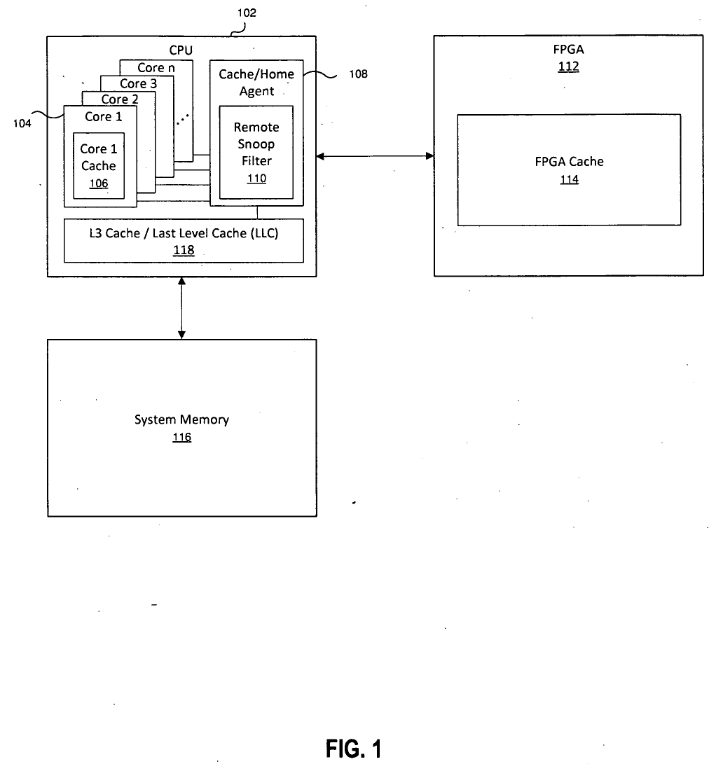

FIG. 1 is a schematic diagram illustrating a high-level view of an exemplary hardware system that includes a CPU 102, an FPGA 112, and a System Memory 116. The CPU 102 further comprises a Caching and Home Agent (“CHA”) 108, an L3 or Last Level Cache (“LLC”) 118, and one or more cores 104 wherein each core contains a core cache 106. A remote snoop filter (“RSF”) 110 is implemented by the CHA 108 for storing the address and state of each cache lines cached in the FPGA cache 114. The RSF 110 may be implemented as a fully associative array or as any other suitable data structure. While FIG. 1 shows only one CPU 102 and one FPGA 112, additional CPUs and FPGAs may be configured. The CPU 102 and FPGA 112 are connected through a high-speed interconnect and they may be implemented on the same package or on different packages, depending on the hardware configuration choice.

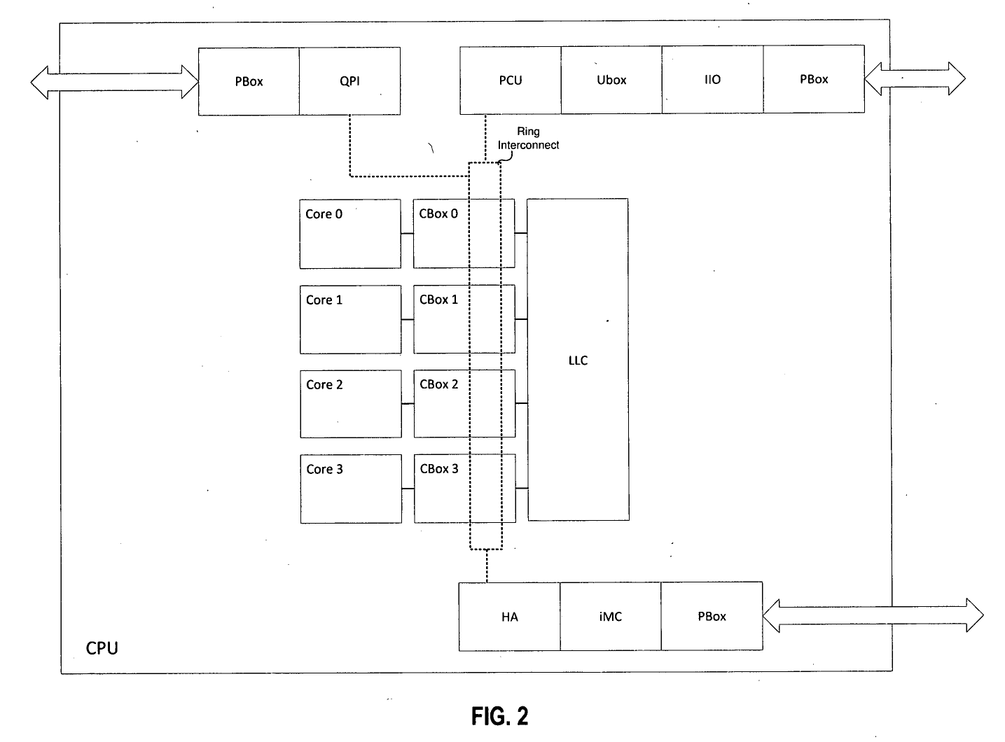

FIG. 2 is a block diagram illustrating an uncore subsystem for a single socket CPU according to one embodiment. The uncore subsystem includes various components such as caching agents (CBox 0-3), power controller unit (PCU), integrated memory controller (iMC) and home agent (HA). The caching agent manages the interface between the core and the last level cache (“LLC”). All core transactions that accesses the LLC are directed from the core to a caching agent via the ring interconnect. The caching agent is responsible for managing data delivery from the LLC to the requesting core. It is also responsible for maintaining coherency between the cores within the socket that share the LLC, as well as generating snoops and collecting snoop responses from local cores. The home agent is responsible for interfacing with the memory controller, ensuring memory/cache coherency, broadcast snoops to peer caching agents, as well as maintaining a memory directory. The caching agents and the home agent are connected by an on-die high-speed interconnect. A ring is shown but other connection types, such as a mesh, crossbar, or point-to-point, may also be used. The caching agent and the home agent are collectively referred to Caching and Home Agent (“CHA”).

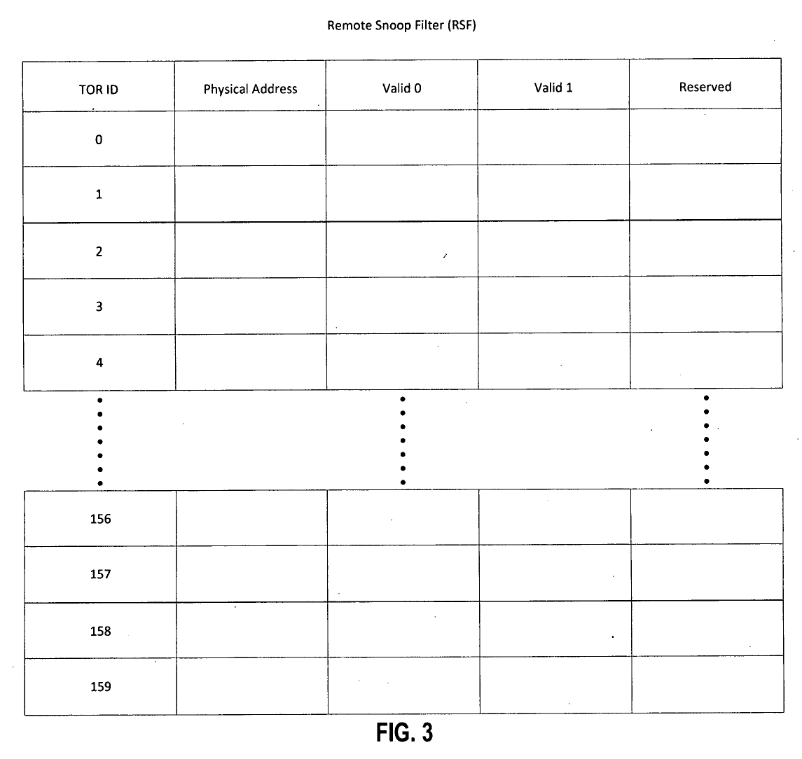

FIG. 3 illustrates an exemplary implementation of the RSF according to one embodiment. The RSF is used to track the address and state of all cache lines present in the FPGA caches in the system. The size of the RSF corresponds to the size of the FPGA cache. In the exemplary embodiment, the RSF contains 160 entries (ID 0-159). For each cache line present in the FPGA cache, regardless of the state, an entry corresponding to the cache line exists in the RSF. Each RSF entry comprises a physical address, a RESERVED bit, and one or more VALID bits. The physical address is the address of the cache line tracked by the entry. The RESERVED bit is used to lock up an entry if it is currently being accessed or modified by a pending request to prevent collision. The VALID bit is used to indicate whether an FPGA contains the cache line tracked by the entry. Each valid bit corresponds to one FPGA and thus the number of VALID bits used in the entry equals the number of FPGAs present in the system. In FIG. 3, the RSF contains two VALID bits (Valid 0 and Valid 1) which signifies two FPGAs in the system. Cache lines cached in the FPGA cache, regardless of state, is tracked by a corresponding entry in the RSF. A cache line without an entry in the RSF is presumed to not be in any FPGA in the system. The cache line hit/miss result from the RSF is used by the CHA to determine whether or not to filter out snoops to a particular FPGA. This ensures that the FPGA sockets are generally not snooped unless necessary. The RSF is an independent structure and does not interact with any of the local coherence flows, thus making it severable in a modular SoC design.

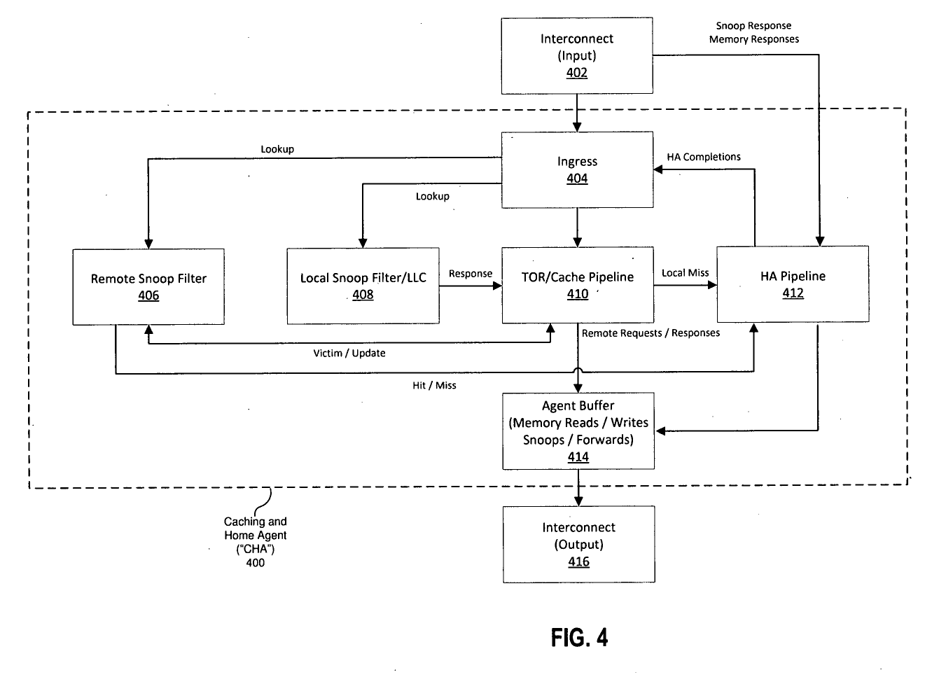

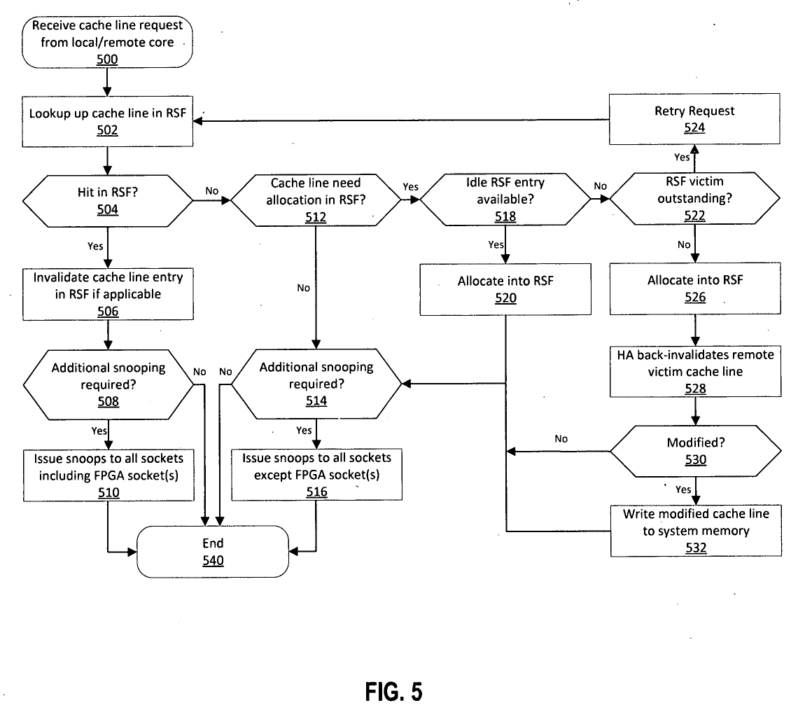

FIG. 4 is a block diagram illustrating an abstracted high-level view of a Cache and Home Agent (“CHA”) implementation according to one embodiment. This is only intended to show a high-level workflow. The detailed operations and logic of the CHA and Remote Snoop Filter (“RSF”) will be explained by FIG. 5 in the next section. The Interconnect (Input) 402 and Interconnect (Output) 416 connects the CHA to local cores, remote sockets (e.g., CPU and FPGA), and system memory. The interconnect may be any suitable high-speed on-die connection such as ring, mesh, crossbar, point-to-point, etc. An ingress mechanism or logic 404 receives and processes a cache line request coming in through the Interconnect 402. The cache line request is looked up in the RSF 406 to determine if the requested cache line is cached in any of the FPGAs in the system. The hit/miss result from the RSF lookup is sent to the HA pipeline 412. The HA pipeline 412 deals with read and write requests that need to be send to memory. It also uses the memory directory state and the result from the RSF lookup to determining if additional sockets in the system need to be snooped and whether or not to filter the FPGA from these snoops. The hit/miss result from the RSF may also trigger a victim/update mechanism if a cache line request needs to be allocated into the RSF by evicting an existing entry in the RSF. The victim/update mechanism processes the evicted entry and enters the appropriate requests into the TOR (Table of Requests)/Cache Pipeline 410.

In parallel to looking up the cache line request in the RSF, a lookup is also performed in the Snoop Filter and Last Level Cache 408. The Snoop Filter and Last Level Cache 408 is a directory containing what is being cached in the local core cache and LLC. It is used for maintaining local cache coherency. The hit/miss result of this look up is fed into into the TOR/Cache Pipeline 410 and processed to generate an appropriate response. The response may include responding to the requesting core with the cache line or notifying the HA pipeline about a local miss. The response generated from TOR/Cache Pipeline 410 and HA Pipeline are queue in the Agent Buffer 414 before outputting to the Interconnect 416.

FIG. 5 is a flow chart illustrating the operations and logic for implementing a Remote Snoop Filter (“RSF”) in the Cache and Home Agent (“CHA”) for one or more Field Programmable Gate Arrays (“FPGAs”) according to one embodiment. In block 500, the CHA 108 receives a cache line request from, for example, a local core as the result of a local cache miss or from a remote core as the result of a remote cache miss. Next, in block 502, the CHA 108 performs a lookup of the cache line request in the RSF 110. In parallel to the RSF lookup, the CHA 108 also performs a lookup of the cache line request in the local snoop filter and Last Level Cache (LLC) 118. In block 504, the CHA 108 determines whether the cache line request matches any entry in the RSF 110. A match or a hit in the RSF 110 may, if applicable, cause the CHA 108 to invalidate the matched RSF cache line entry in block 506. A matched RSF cache line entry is invalidated if the cache line request is, for instance, an ownership request by a requesting core or thread to invalidate all other cached copies of the requested cache line. Next, in block 508, the CHA 108 determines, based on the request type and memory directory state, whether additional snooping is required. If no additional snooping is required, such as the case in an ownership request, the process ends at block 540 and no other sockets, including any FPGA sockets, are snooped. On the other hand, if in block 508 the CHA 108 determines that further snooping is required, the CHA 108 would issue snoops to all enabled sockets in the system, including any FPGA sockets, at block 510. After the CHA issues these snoops, the operation is complete at block 540.

However, if back at block 504 the request lookup in the RSF 110 resulted in a miss, the CHA 108 would next, in block 512, determine whether an entry corresponding to the cache line request should be allocated in the RSF 110. An entry should be allocated in the RSF 110 when the cache line request is writing to the FPGA cache 114. However, if the cache line request is not writing to the FPGA cache 114, it does not need to be tracked by the RSF 110 and thus the CHA 108 simply determines, at block 514, whether additional snooping is required based on the request type and the memory directory state. If no further snooping is required, the operation is complete at block 540. However, if further snooping is required, the CHA, in block 516, would issue snoops to all sockets except the FPGA sockets. The FPGA sockets are excluded from the snoops because the miss from the RSF lookup serves as an indication that the requested cache line is not present in any of the FPGA caches.

Returning to block 512, if an entry needs to be allocated into the RSF 110, the CHA 108 next determines, at block 518, whether an idle entry is available in the RSF 110. An idle entry may an empty entry or a stale entry marked for deletion (e.g., entry with all VALID bits marked 0). If an idle entry is available in the RSF 110, the CHA 108 simply writes the cache line from the cache line request into the idle entry at block 520. Then, in block 514, the CHA 108 determines whether more sockets need to be snooped based on the request type and memory state directory information. If no more sockets need to be snooped, the operation is complete at block 540. Otherwise, the CHA 108 issues snoops to all enabled sockets except the FPGA sockets. Again, the FPGA sockets are excluded due to the RSF miss.

If the CHA 108 determined back at block 518 that no idle entries are available in the RSF 110, it then starts a victim eviction process to free up an entry in the RSF. The victim eviction process begins in block 522 where the CHA 108 determines whether a victim is already outstanding from a previous cache line request that is still pending. This may be indicated by the RESERVED bit in the entry. If a victim is already outstanding, the CHA 108 does not attempt to select and evict another victim as each victim eviction requires additional overhead and resources such as dedicated storage and address comparison logic. Instead, in block 524, the CHA simply retries the cache line request which in turn, restarts the operation again at block 502. On the other hand, if at block 522 no victim was outstanding, the CHA 108 would then move forward with the victim eviction process by evicting a victim cache line from the RSF 110 and allocating the newly freed entry space to the cache line request at block 526. In block 528, the CHA 108 back invalidates the evicted victim cache line by sending an invalidation request to the appropriate cores and sockets. Then in block 530, the CHA 108 determines whether the evicted victim cache line was modified (e.g., dirty bit set to true) and thus need to be updated in system memory. The write back of the victim cache line to system memory is performed in block 532. Then, after the write back, or if one was not necessary, the CHA 108 determines if other sockets need to be snooped based on request type and memory directory state in block 514. If no additional snoops are required, the operation is complete at block 540. However, if additional sockets need, to be snooped, the CHA 108 issues snoop request to all other sockets except the FPGA in block 516.

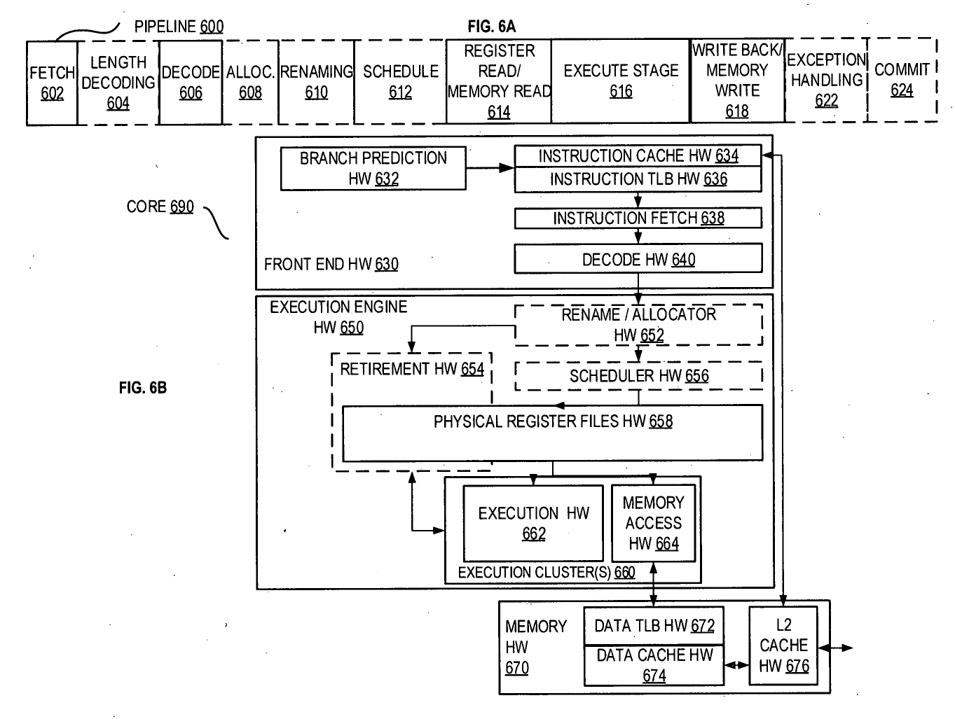

FIG. 6A is a block diagram illustrating both an exemplary in-order pipeline and an exemplary register renaming, out-of-order issue/execution pipeline according to embodiments of the invention. FIG. 6B is a block diagram illustrating both an exemplary embodiment of an in-order architecture core and an exemplary register renaming, out-of-order issue/execution architecture core to be included in a processor according to embodiments of the invention. The solid lined boxes in FIGS. 6A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 6A, a processor pipeline 600 includes a fetch stage 602, a length decode stage 604, a decode stage 606, an allocation stage 608, a renaming stage 610, a scheduling (also known as a dispatch or issue) stage 612, a register read/memory read stage 614, an execute stage 616, a write back/memory write stage 618, an exception handling stage 622, and a commit stage 624.

FIG. 6B shows processor core 690 including a front end hardware 630 coupled to an execution engine hardware 650, and both are coupled to a memory hardware 670. The core 690 may be a reduced instruction set computing (RISC) core, a complex instruction set computing (CISC) core, a very long instruction word (VLIW) core, or a hybrid or alternative core type. As yet another option, the core 690 may be a special-purpose core, such as, for example, a network or communication core, compression engine, coprocessor core, general purpose computing graphics processing unit (GPGPU) core, graphics core, or the like.

The front end hardware 630 includes a branch prediction hardware 632 coupled to an instruction cache hardware 634, which is coupled to an instruction translation lookaside buffer (TLB) 636, which is coupled to an instruction fetch hardware 638, which is coupled to a decode hardware 640. The decode hardware 640 (or decoder) may decode instructions, and generate as an output one or more micro-operations, micro-code entry points, microinstructions, other instructions, or other control signals, which are decoded from, or which otherwise reflect, or are derived from, the original instructions. The decode hardware 640 may be implemented using various different mechanisms. Examples of suitable mechanisms include, but are not limited to, look-up tables, hardware implementations, programmable logic arrays (PLAs), microcode read only memories (ROMs), etc. In one embodiment, the core 690 includes a microcode ROM or other medium that stores microcode for certain macroinstructions (e.g., in decode hardware 640 or otherwise within the front end hardware 630). The decode hardware 640 is coupled to a rename/allocator hardware 652 in the execution engine hardware 650.

The execution engine hardware 650 includes the rename/allocator hardware 652 coupled to a retirement hardware 654 and a set of one or more scheduler hardware 656. The scheduler hardware 656 represents any number of different schedulers, including reservations stations, central instruction window, etc. The scheduler hardware 656 is coupled to the physical register file(s) hardware 658. Each of the physical register file(s) hardware 658 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) hardware 658 comprises a vector registers hardware, a write mask registers hardware, and a scalar registers hardware. These register hardware may provide architectural vector registers, vector mask registers, and general purpose registers. The physical register file(s) hardware 658 is overlapped by the retirement hardware 654 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement hardware 654 and the physical register file(s) hardware 658 are coupled to the execution cluster(s) 660. The execution cluster(s) 660 includes a set of one or more execution hardware 662 and a set of one or more memory access hardware 664. The execution hardware 662 may perform various operations (e.g., shifts, addition, subtraction, multiplication) and on various types of data (e.g., scalar floating point, packed integer, packed floating point, vector integer, vector floating point). While some embodiments may include a number of execution hardware dedicated to specific functions or sets of functions, other embodiments may include only one execution hardware or multiple execution hardware that all perform all functions. The scheduler hardware 656, physical register file(s) hardware 658, and execution cluster(s) 660 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler hardware, physical register file(s) hardware, and/or execution cluster—and in the case of a separate memory access pipeline, certain embodiments are implemented in which only the execution cluster of this pipeline has the memory access hardware 664). It should also be understood that where separate pipelines are used, one or more of these pipelines may be out-of-order issue/execution and the rest in-order.

The set of memory access hardware 664 is coupled to the memory hardware 670, which includes a data TLB hardware 672 coupled to a data cache hardware 674 coupled to a level 2 (L2) cache hardware 676. In one exemplary embodiment, the memory access hardware 664 may include a load hardware, a store address hardware, and a store data hardware, each of which is coupled to the data TLB hardware 672 in the memory hardware 670. The instruction cache hardware 634 is further coupled to a level 2 (L2) cache hardware 676 in the memory hardware 670. The L2 cache hardware 676 is coupled to one or more other levels of cache and eventually to a main memory.

By way of example, the exemplary register renaming, out-of-order issue/execution core architecture may implement the pipeline 600 as follows: 1) the instruction fetch 638 performs the fetch and length decoding stages 602 and 604; 2) the decode hardware 640 performs the decode stage 606; 3) the rename/allocator hardware 652 performs the allocation stage 608 and renaming stage 610; 4) the scheduler hardware 656 performs the schedule stage 612; 5) the physical register file(s) hardware 658 and the memory hardware 670 perform the register read/memory read stage 614; the execution cluster 660 perform the execute stage 616; 6) the memory hardware 670 and the physical register file(s) hardware 658 perform the write back/memory write stage 618; 7) various hardware may be involved in the exception handling stage 622; and 8) the retirement hardware 654 and the physical register file(s) hardware 658 perform the commit stage 624.

The core 690 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 690 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache hardware 634/674 and a shared L2 cache hardware 676, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

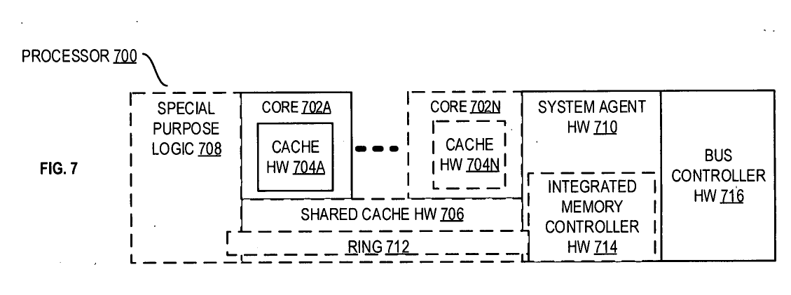

FIG. 7 is a block diagram of a processor 700 that may have more than one core, may have an integrated memory controller, and may have integrated graphics according to embodiments of the invention. The solid lined boxes in FIG. 7 illustrate a processor 700 with a single core 702A, a system agent 710, a set of one or more bus controller hardware 716, while the optional addition of the dashed lined boxes illustrates an alternative processor 700 with multiple cores 702A-N, a set of one or more integrated memory controller hardware 714 in the system agent hardware 710, and special purpose logic 708.

Thus, different implementations of the processor 700 may include: 1) a CPU with the special purpose logic 708 being integrated graphics and/or scientific (throughput) logic (which may include one or more cores), and the cores 702A-N being one or more general purpose cores (e.g., general purpose in-order cores, general purpose out-of-order cores, a combination of the two); 2) a coprocessor with the cores 702A-N being a large number of special purpose cores intended primarily for graphics and/or scientific (throughput); and 3) a coprocessor with the cores 702A-N being a large number of general purpose in-order cores. Thus, the processor 700 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 700 may, be a part of and/or may be implemented on one or more substrates using any of a number of process technologies, such as, for example, BiCMOS, CMOS, or NMOS.

The memory hierarchy includes one or more levels of cache within the cores, a set or one or more shared cache hardware 706, and external memory (not shown) coupled to the set of integrated memory controller hardware 714. The set of shared cache hardware 706 may include one or more mid-level caches, such as level 2 (L2), level 3 (L3), level 4 (L4), or other levels of cache, a last level cache (LLC), and/or combinations thereof. While in one embodiment a ring based interconnect hardware 712 interconnects the integrated graphics logic 708, the set of shared cache hardware 706, and the system agent hardware 710/integrated memory controller hardware 714, alternative embodiments may use any number of well-known techniques for interconnecting such hardware. In one embodiment, coherency is maintained between one or more cache hardware 706 and cores 702-A-N.

In some embodiments, one or more of the cores 702A-N are capable of multi-threading. The system agent 710 includes those components coordinating and operating cores 702A-N. The system agent hardware 710 may include for example a power control unit (PCU) and a display hardware. The PCU may be or include logic and components needed for regulating the power state of the cores 702A-N and the integrated graphics logic 708. The display hardware is for driving one or more externally connected displays.

The cores 702A-N may be homogenous or heterogeneous in terms of architecture instruction set; that is, two or more of the cores 702A-N may be capable of execution the same instruction set, while others may be capable of executing only a subset of that instruction set or a different instruction set. In one embodiment, the cores 702A-N are heterogeneous and include both the “small” cores and “big” cores described below.

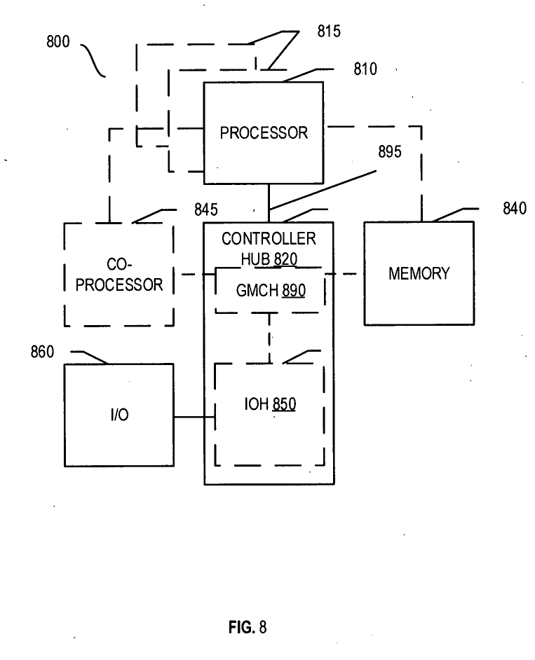

FIGS. 8-11 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 8, shown is a block diagram of a system 800 in accordance with one embodiment of the present invention. The system 800 may include one or more processors 810, 815, which are coupled to a controller hub 820. In one embodiment the controller hub 820 includes a graphics memory controller hub (GMCH) 890 and an Input/Output Hub (IOH) 850 (which may be on separate chips); the GMCH 890 includes memory and graphics controllers to which are coupled memory 840 and a coprocessor 845; the IOH 850 is couples input/output (I/O) devices 860 to the GMCH 890. Alternatively, one or both of the memory and graphics controllers are integrated within the processor (as described herein), the memory 840 and the coprocessor 845 are coupled directly to the processor 810, and the controller hub 820 in a single chip with the IOH 850.

The optional nature of additional processors 815 is denoted in FIG. 8 with broken lines. Each processor 810, 815 may include one or more of the processing cores described herein and may be some version of the processor 700.

The memory 840 may be, for example, dynamic random access memory (DRAM), phase change memory (PCM), or a combination of the two. For at least one embodiment, the controller hub 820 communicates with the processor(s) 810, 815 via a multi-drop bus, such as a frontside bus (FSB), point-to-point interface, or similar connection 895.

In one embodiment, the coprocessor 845 is a special-purpose processor, such as, for example, a high-throughput MIC processor, a network or communication processor, compression engine, graphics processor, GPGPU, embedded processor, or the like. In one embodiment, controller hub 820 may include an integrated graphics accelerator.

There can be a variety of differences between the physical resources 810, 815 in terms of a spectrum of metrics of merit including architectural, microarchitectural, thermal, power consumption characteristics, and the like.

In one embodiment, the processor 810 executes instructions that control data processing operations of a general type. Embedded within the instructions may be coprocessor instructions. The processor 810 recognizes these coprocessor instructions as being of a type that should be executed by the attached coprocessor 845. Accordingly, the processor 810 issues these coprocessor instructions (or control signals representing coprocessor instructions) on a coprocessor bus or other interconnect, to coprocessor 845. Coprocessor(s) 845 accept and execute the received coprocessor instructions.

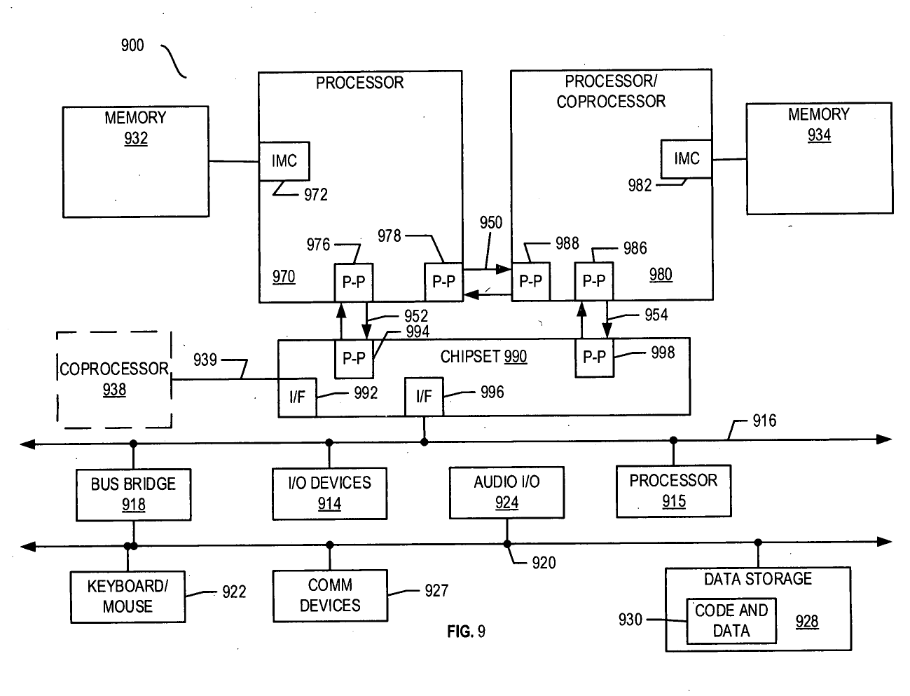

Referring now to FIG. 9, shown is a block diagram of a first more specific exemplary system 900 in accordance with an embodiment of the present invention. As shown in FIG. 9, multiprocessor system 900 is a point-to-point interconnect system, and includes a first processor 970 and a second processor 980 coupled via a point-to-point interconnect 950. Each of processors 970 and 980 may be some version of the processor 700. In one embodiment of the invention, processors 970 and 980 are respectively processors 810 and 815, while coprocessor 938 is coprocessor 845. In another embodiment, processors 970 and 980 are respectively processor 810 coprocessor 845.

Processors 970 and 980 are shown including integrated memory controller (IMC) hardware 972 and 982, respectively. Processor 970 also includes as part of its bus controller hardware point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, 998. Chipset 990 may optionally exchange information with the coprocessor 938 via a high-performance interface 939. In one embodiment, the coprocessor 938 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope of the present invention is not so limited.

As shown in FIG. 9, various I/O devices 914 may be coupled to first bus 916, along with a bus bridge 918 which couples first bus 916 to a second bus 920. In one embodiment, one or more additional processor(s) 915, such as coprocessors, high-throughput MIC processors, GPGPU's, accelerators (such as, e.g., graphics accelerators or digital signal processing (DSP) hardware), field programmable gate arrays, or any other processor, are coupled to first bus 916. In one embodiment, second bus 920 may be a low pin count (LPC) bus. Various devices may be coupled to a second bus 920 including, for example, a keyboard and/or mouse 922, communication devices 927 and a storage hardware 928 such as a disk drive or other mass storage device which may include instructions/code and data 930, in one embodiment. Further, an audio I/O 924 may be coupled to the second bus 920. Note that other architectures are possible. For example, instead of the point-to-point architecture of FIG. 9, a system may implement a multi-drop bus or other such architecture.

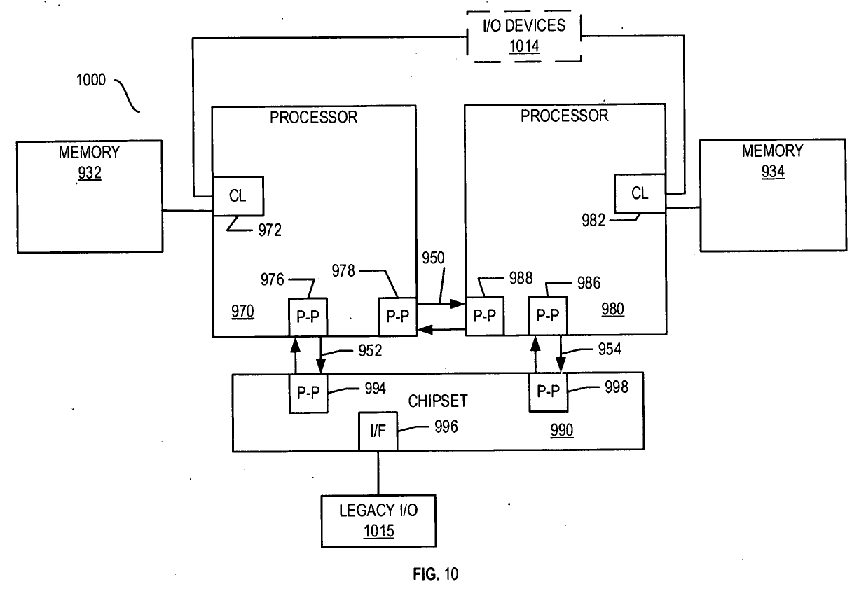

Referring now to FIG. 10, shown is a block diagram of a second more specific exemplary system 1000 in accordance with an embodiment of the present invention. Like elements in FIGS. 9 and 10 bear like reference numerals, and certain aspects of FIG. 9 have been omitted from FIG. 10 in order to avoid obscuring other aspects of FIG. 10.

FIG. 10 illustrates that the processors 970, 980 may include integrated memory and I/O control logic (“CL”) 972 and 982, respectively. Thus, the CL 972, 982 include integrated memory controller hardware and include I/O control logic. FIG. 10 illustrates that not only are the memories 932, 934 coupled to the CL 972, 982, but also that I/O devices 1014 are also coupled to the control logic 972, 982. Legacy I/O devices 1015 are coupled to the chipset 990.

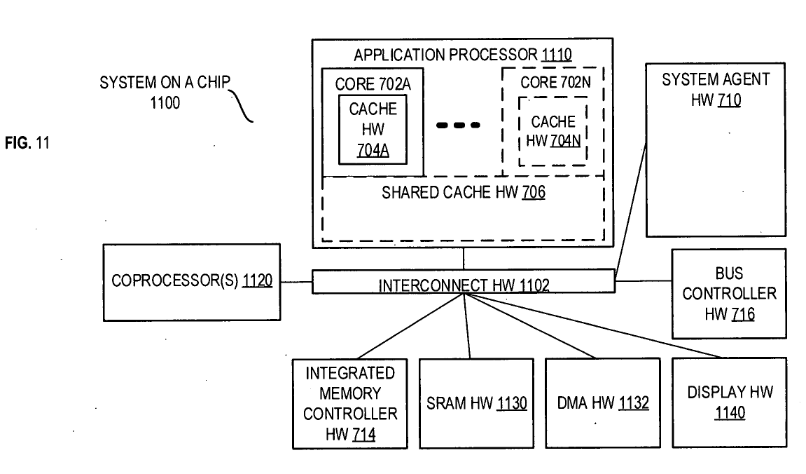

Referring now to FIG. 11, shown is a block diagram of a SoC 1100 in accordance with an embodiment of the present invention. Similar elements in FIG. 7 bear like reference numerals. Also, dashed lined boxes are optional features on more advanced SoCs. In FIG. 11, an interconnect hardware 1102 is coupled to: an application processor 1110 which includes a set of one or more cores 702A-N and shared cache hardware 706; a system agent hardware 710; a bus controller hardware 716; an integrated memory controller hardware 714; a set or one or more coprocessors 1120 which may include integrated graphics logic, an image processor, an audio processor, and a video processor; an static random access memory (SRAM) hardware 1130; a direct memory access (DMA) hardware 1132; and a display hardware 1140 for coupling to one or more external displays. In one embodiment, the coprocessor(s) 1120 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 930 illustrated in FIG. 9, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed, by the core. The instruction converter may be implemented in software, hardware, firmware, or a combination thereof. The instruction converter may be on processor, off processor, or part on and part off processor.

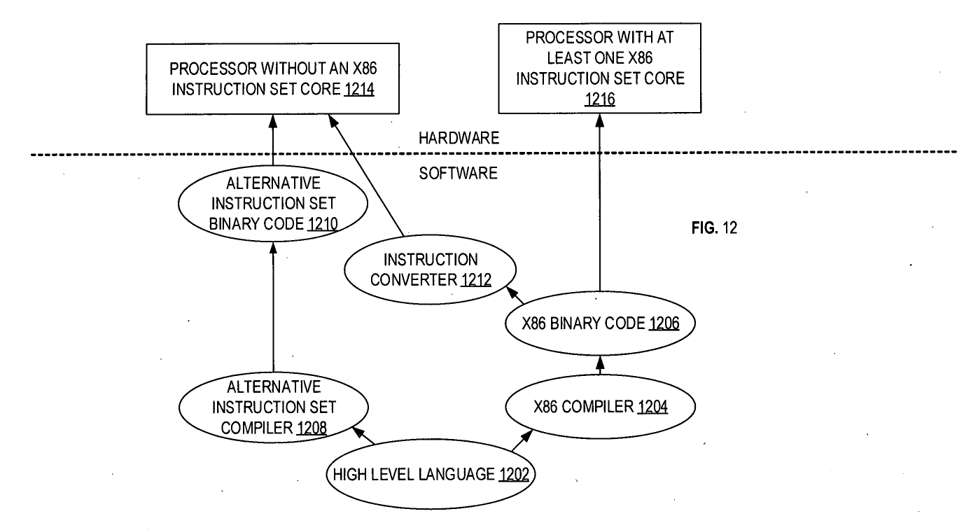

FIG. 12 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 12 shows a program in a high level language 1202 may be compiled using an x86 compiler 1204 to generate x86 binary code 1206 that may be natively executed by a processor with at least one x86 instruction set core 1216. The processor with at least one x86 instruction set core 1216 represents any processor that can perform substantially the same functions as an Intel processor with at least one x86 instruction set core by compatibly executing or otherwise processing (1) a substantial portion of the instruction set of the Intel x86 instruction set core or (2) object code versions of applications or other software targeted to run on an Intel processor with at least one x86 instruction set core, in order to achieve substantially the same result as an Intel processor with at least one x86 instruction set core. The x86 compiler 1204 represents a compiler that is operable to generate x86 binary code 1206 (e.g., object code) that can, with or without additional linkage processing, be executed on the processor with at least one x86 instruction set core 1216. Similarly, FIG. 12 shows the program in the high level language 1202 may be compiled using an alternative instruction set compiler 1208 to generate alternative instruction set binary code 1210 that may be natively executed by a processor without at least one x86 instruction set core 1214 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1212 is used to convert the x86 binary code 1206 into code that may be natively executed by the processor without an x86 instruction set core 1214. This converted code is not likely to be the same as the alternative instruction set binary code 1210 because an instruction converter capable of this is difficult to make; however, the converted code will accomplish the general operation and be made up of instructions from the alternative instruction set. Thus, the instruction converter 1212 represents software, firmware, hardware, or a combination thereof that, through emulation, simulation or any other process, allows a processor or other electronic device that does not have an x86 instruction set processor or core to execute the x86 binary code 1206.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus comprising:
one or more field programmable gate arrays (“FPGAs”), wherein each of the one or more FPGAs to include an FPGA cache;
a hardware processor comprising a caching and home agent circuit that is communicatively coupled to and shared by the one or more FPGAs, wherein the caching and home agent circuit to:
monitor cache lines stored in the FPGA cache for each of the one or more FPGAs;
maintain a Remote Snoop Filter (“RSF”) for storing cache line entries, wherein each stored cache line entry corresponds to a cache line stored in the FPGA cache of the one or more FPGAs;
determine whether a requested cache line from an incoming cache line request is present in the FPGA cache for each of one or more FPGAs based on the cache line entries stored in the RSF, wherein a snoop request is allowed to issue to FPGAs that contain the requested cache line and not allowed to issue to FPGAs that do not;

2. The apparatus of claim 1, wherein each cache line entry stored in the RSF comprises a cache line physical addresses, a RESERVED bit, and one or more VALID bits.

3. The apparatus of claim 2, wherein each of the one or more VALID bits correspond to one of the one or more FPGAs.

4. The apparatus of claim 3, wherein a marked VALID bit to indicate that the corresponding FPGA contains the cache line in the cache line entry and an unmarked VALID bit to indicate that the corresponding FPGA does not contain the cache line in the cache line entry.

5. The apparatus of claim 4 wherein a first FPGA contains the requested cache line from the incoming cache line request if an entry in the RSF matches the requested cache line from the incoming cache line request and the entry's VALID bit corresponding to the first FPGA is marked valid.

6. The apparatus of claim 5, wherein if no entry in the RSF matches the requested cache line from the incoming cache line request, the home agent to further determine whether the requested cache line from the incoming cache line request should be stored into the RSF.

7. The apparatus of claim 6, wherein determining whether the requested cache line from the incoming cache line request should be stored in the RSF is based on the incoming cache line request's type.

8. The apparatus of claim 6, wherein storing the requested cache line from the incoming cache line request into the RSF comprises determining if an idle entry is available in the RSF.

9. The apparatus of claim 8, wherein if no idle entry is available, the CHA evicts a victim entry to vacate a slot in the RSF and then stores the requested cache line in the vacated slot.

10. An method implemented in a hardware processor, the method comprising:
monitoring cache lines stored in one or more Field Programmable Gate Arrays (“FPGAs”);
maintaining a Remote Snoop Filter (“RSF”) for storing cache line entries, wherein each stored cache line entry corresponds to a cache line stored in the one or more FPGAs;
determining whether a requested cache line from an incoming cache line request is present in the one or more FPGAs based on the cache line entries stored in the RSF, wherein a snoop request is allowed to issue to FPGAs that contain the requested cache line and not allowed to issue to FPGAs that do not;

11. The method of claim 10, wherein determining whether a requested cache line from an incoming cache line request is present in the one or more FPGAs further comprises determining whether one of the entries stored in the RSF matches the requested cache line from the incoming cache line request.

12. The method of claim 10, further comprises determining whether the requested cache line from the incoming cache line request should be stored in the RSF based on the incoming cache line request's type.

13. The method of claim 12, further comprises determining if an idle entry is available in the RSF.

14. The method of claim 13, further comprises of evicting a victim entry to vacate a slot in the RSF and storing the requested cache line into the vacated slot.
